(19) United States
(12) Patent Application Publication
(10) Pub. No.: US 2002/0164271 A1
(43) Pub. Date: Nov. 7, 2002

(54) Wavelength-coded bead for bioassay and signature recogniton

(76) Inventor: Winston Z. Ho, Hacienda Heights, CA (US)

Correspondence Address: Winston Z. Ho, 14541 Langhill Drive, Hacienda Heights, CA, 91745, US

(21) Appl. No.: 10/137,461

(22) Filed: Apr. 29, 2002

Related U.S. Application Data
(60) Provisional application No. 60/287,809, filed on May 2, 2001.

(51) Int. Cl. G01N 21/76

(52) U.S. Cl. 422/82.08; 422/82.05; 436/164; 436/172; 250/492.2

(57) ABSTRACT

The disclosure describes a method to utilize semiconductor-based nanocrystals to optically code microspheres, such as latex beads or magnetic beads. Semiconductor-based nanocrystals light up like LEDs, emitting a range of different colored lights depending on their sizes when exposed to light. When a microsphere formed by impregnating a mixture of nanometer scale crystals, infinite number of codes can be generated. The novelty of the technology is that microspheres can identify which reaction is taking place on the surface. Each latex bead can perform one test, thus each latex bead is a single analyte analyzer. By adding a mixture of latex beads, several thousand analytes can be tested simultaneously, easily, rapidly, and inexpensively. The bar-code microspheres can be applied to other applications, such as signature recognition and security identification.

### RELATED APPLICATION

The present application claims the benefit of 35 U.S.C. 111(b) Provisional applications Ser. No. 60/287,809 filed May 2, 2001 entitled “Wavelength-coded Bead for Bioassay”.

### FIELD OF THE INVENTION

The invention is related to utilize the unique properties of nanometer-scale semiconductor crystals to provide a multiplexed optical coding capability for micrometer-scale microspheres. Micrometer-scale spheres, such as latex beads and magnetic beads are ideal for bioassays, and have been used for various applications in biotechnology. Utilizing optically coded latex beads, thousands of analytes can be tested simultaneously.

### BACKGROUND OF THE INVENTION

Semiconductor nanocrystals, known as Quantum dots, are stable, nanometer-scale crystals, made of inorganic materials (e.g. CdSe, InP, ZnS, CdS, CdTe, InAs, and PbS). The properties of quantum dots result from quantum-size confinement, which occurs when metal and semiconductor particles are smaller than their exciton Bohr radii (about 1-10 nm). Quantum dots light up like LEDs, emitting a range of different colored lights when exposed to blue or UV light. Quantum dot luminescent materials are 20 times brighter, and 100 times more stable when compared to photobleaching, and 3 times narrower in spectral linewidth when compared with organic fluorescence dyes. Size-dependent nanocrystals offer emission spectra (400 nm-2 μm) with typical emission widths of 20 nm, no red tail, and a large extinction coefficient ˜10⁵ M⁻¹ cm⁻¹. More importantly, various sizes of quantum dots can be excited with a single wavelength. Quantum dot crystals were developed at Lawrence Berkeley National Laboratory, the Massachusetts Institute of Technology, and Indiana University. U.S. Pat. No. 6,326,144 and U.S. Pat. No. 6,306,610 disclosed the uses of quantum dots for fluorescent dyes and labels. Various functional groups were developed for binding semiconductor nanocrystals to biological molecules. Water-soluble quantum dots, described in U.S. Pat. No. 6,319,426, was developed to improve the solubility in aqueous solution. The typical size of a quantum dot is from 2 nm to 10 nm. Several companies (e.g. Quantum Dot Corp., Evident Technologies, Biodots, etc.) are commercializing quantum dot particles.

Interest in the use of regular and magnetic microspheres for immunological and nucleic acid assays has increased dramatically over the past ten years. Latex beads and magnetic beads are ideal for solid phase assays, and have been used for radioimmunoassays, ELISA, FIA, cell separation, and chemiluminescence immunoassays, and various applications in nucleic acids and molecular biology. Test strips, flow cytometers, and microfluidic devices all use latex beads as transporting vehicle. Microspheres are made of polystyrene, acrylic acid, acrylamide, and silica. Polystyrene is a hydrophobic polymer; it absorbs proteins easily by non-covalent bonding. Silica microspheres are naturally hydrophilic, so no protein should be adsorbed nonspecifically onto them. Magnetic particles are used to concentrate analyte molecules. Magnetic beads are superparamagnetic, meaning that they have neither magnetic remainance nor hysteresis, in other words, they respond to a magnetic field, but completely demagnetize when the field is removed. Thus microspheres can be easily separated from the liquid phase with a small magnet, but can be redispersed without clumping, immediately after the magnet is removed.

Latex-based fluorescent beads are conventionally coated with Rhodamine, Texas Red, fluorescein, and coumarin. Recently, the Luminex Corporation has utilized two organic dyes, green and red, to internally code the latex beads, then the beads are identified by detecting the fluorescent intensity ratio from the two dyes. Unfortunately, there are three problems associated with the organic dyes method:

1. The fluorescent spectra of organic dyes are broad (˜80 nm) and overlapping. Bar-code numbers based on two organic dyes are limited. Multiplexing often creates false color-code readings.

2. Organic dyes are easily photobleached, especially for single bead illumination.

3. Organic dyes often require more than one excitation wavelengths. For example, three-laser system has been used to measure 10 parameters with flow cytometry.

### SUMMARY OF THE INVENTION

The invention is to provide a multiplexing approach to optically bar code microspheres with the incorporation of semiconductor nanocrystals.

One of the objects of the present invention is to provide wavelength-coded quantum dots (WCQD) latex beads for biological assay applications. When latex beads are immobilized with biological probes, a variety of analytes in a sample can be identified and quantified.

One of the objects of the present invention is to utilize WCQB's narrow (˜20 nm) fluorescence bands to increase the number of codes. After multiplexing both wavelength, (W), and intensity, (I), a very large number of optical codes, I^{W}, can be fabricated.

Although the illustration in this invention focus on biological assays, it is also an object of the present invention to provide microspheres with optical codes for signature identification application. The present invention in fact provides a new optical bar-code method for very small or micrometer scale subjects. The bar-code microspheres can be applied to other applications, such as signature recognition and security identification. It should be understood, however, that the detail description and specific examples, while indicating preferred embodiments of the present invention, are giving by way of illustration and not of limitation. Further, as is will become apparent to those skilled in the area, the teaching of the present invention can be applied to various devices and applications.

### BRIEF DESCRIPTION OF THE DRAWING

FIG. 1 is a perspective view of (a) a microsphere or latex bead and (b) a magnetic bead coded with semiconductor nanocrystals. By incorporating various sizes and concentrations of nanocrystals into the microspheres, a large number of latex beads can be optically identified.

FIG. 2 shows fluorescent spectra of semiconductor quantum dots. Size- and material-dependent emission spectra (from right to left) of CdSe nanocrystals with diameters of 2.1, 2.4, 3.1, 3.6, and 4.6 nm, and InP nanocrystals, 3.0, 3.5, and 4.6 nm. The whole groups are excitable by a single wavelength. (M. Bruchez et. al, Science Vol. 281. 2013 (1998)).

FIG. 3 is a perspective view of a WCQB-based microsphere for bioassays. The figure shows an example of a sandwiched immunoassay format.

FIG. 4 is a perspective view of WCQB-based microspheres in a microfluidic system. A mixture of WCQB-based latex beads are optically.

### DETAILED DESCRIPTION OF EMBODIMENTS OF THE INVENTION

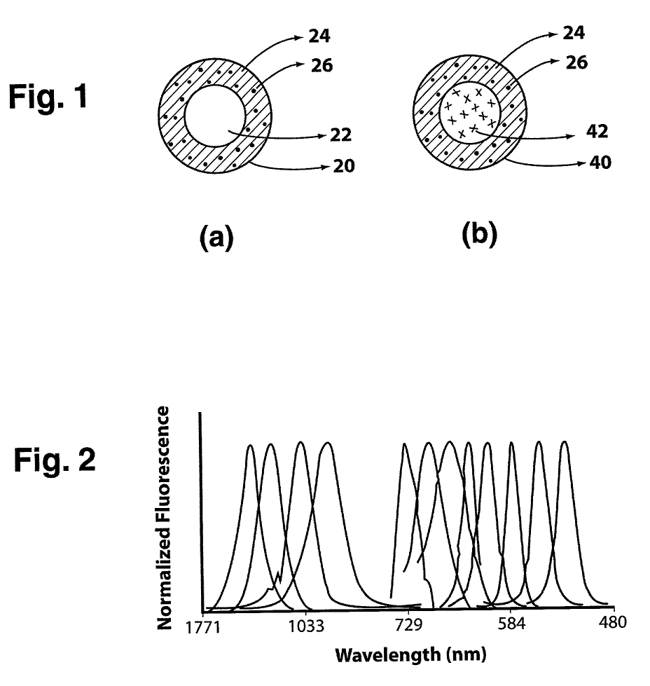

Although there may be different methods of fabricating WCQD-based microspheres, two common methods are: 1. monolithic microspheres, and 2. core-shell microspheres. The monolithic latex beads are prepared by emulsion polymerization with styrene as monomer, potassium persulfate or benzoyl peroxide as polymerization initiator, and nanocrystals (e.g. CdSe) as dopants. The polymerization and incubation process is performed under a series of processes: activate swelling, cross-link porous particles, and polymer coating. The core-shell latex bead 20, in FIG. 1, is prepared by synthesizing a polymer 24/quantum dots 26 shell on the surface of the latex seed 22. The method has been used to grow larger particles by stepwise growing of small particle with the addition of styrene/divinebenzene monomer, and initiator without additional detergent. The WCQD-based magnetic beads 40 can be synthesized using the same method. Various sizes of latex beads 22 and magnetic latex beads 42 (50-1,850 μm) (available from Magsphere Inc., Dynal A. S., and Spherotech Inc.) are used as seeds or core materials. After a slow polymerization process, a layer of CdSe/polystyrene is formed on the seeds. Due to the very small size of quantum dot particles (2-8 nm), even a thin (3 μm) shell can contain several billions quantum dots (ng—pg/per bead) which is sufficient for optical detection. The resulting uniform latex bead is typically in the range of 10-500 μm in diameter, but it can be extended to the range of 0.1 μm-5 mm.

FIG. 2 shows fluorescent spectra of quantum dots of different sizes and semiconductors. By multiplexing various sizes, concentrations, and materials, the microspheres exhibit multiplexed wavelengths and intensities when excited with UV or blue light. The following show the examples of optical multiplexing by incorporating different sizes (nm) and concentration (%) of quantum dots.

Single wavelength:

Latex beads with CdSe—2.4 nm (100%)

Latex beads with CdSe—3.6 nm (100%)

Latex beads with CdSe—4.5 nm (100%)

Two wavelengths

Latex beads with CdSe—2.4 nm (50%)+3.6 nm (50%)

Latex beads with CdSe—2.4 nm (50%)+4.5 nm (50%)

Latex beads with CdSe—3.6 nm (50%)+4.5 nm (50%)

Two wavelengths and two intensities

Latex beads with CdSe—2.4 nm (30%)+3.6 nm (70%)

Latex beads with CdSe—2.4 nm (30%)+4.5 nm (70%)

Latex beads with CdSe—3.6 nm (30%)+4.5 nm (70%)

Three wavelengths:

Latex beads with CdSe—2.4 nm (33.3%)+3.6 nm (33.3%)+4.5 nm (33.3%)

Three wavelengths and two intensities:

Latex beads with CdSe—2.4 nm (60%)+3.6 nm (20%)+4.5 nm (20%)

Latex beads with CdSe—2.4 nm (20%)+3.6 nm (60%)+4.5 nm (20%)

Latex beads with CdSe—2.4 nm (20%)+3.6 nm (20%)+4.5 nm (60%)

The number of codes increases exponentially when multiple wavelengths and multiple intensities are used at the same time. After multiplexing (Wavelength (W)+intensity (I)), a very large number of optical codes, I^{W}, can be fabricated. For example, if there are 10 wavelengths and 3 intensities, the number of potential codes, 3¹⁰=59,049, can be generated.

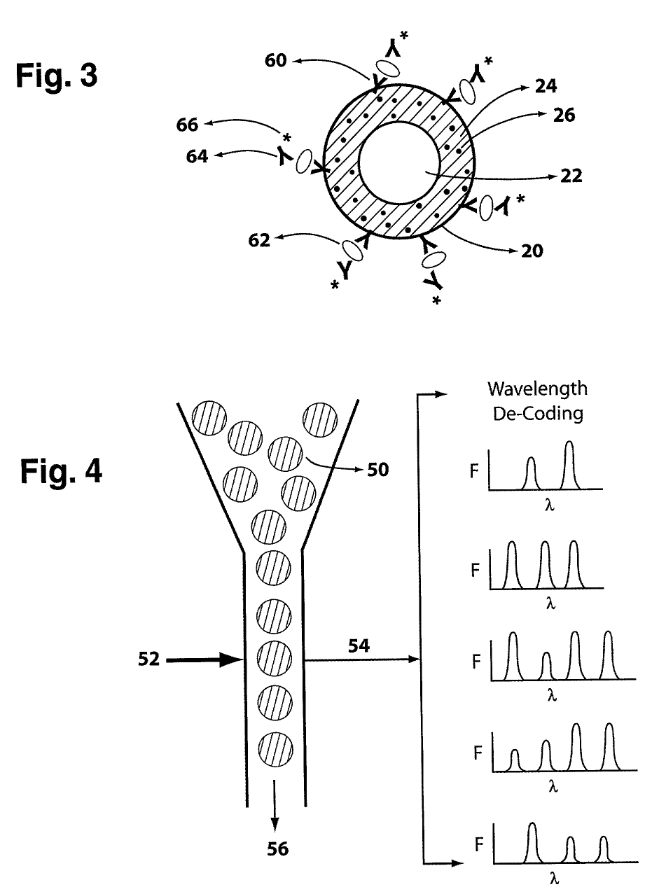

The main interests of WCQB-based latex bead assays are immunoassays (FIG. 3) and nucleic acid assays. The chemistry of latex bead is well established in the clinical diagnostic field. Various functional groups: carboxylic acid (—COOH), primary amine (—NH2), and avidin can be formed on the surface of latex beads to provide reliable and stable binding for biological probes, such as antibody 60 or nucleic acid. Streptavidin interacts strongly with the molecule biotin. The avidinibiotin interaction is one of the strongest non-covalent bonds (Ka=10¹⁵ /M) Biotinylated ligand often serves as a sensitive marker. FIG. 3 shows a common sandwiched immunoassay with the probes binding to the targets 62 (e.g. antigen). The probe-target reaction is detected with a secondary antibody 64 labeled with a fluorescent marker 66. Common markers are detected by enzymatic activity, color, fluorescence, and chemiluminescence methods.

The WCQB-based latex beads require an optical system to read the bar-codes. The accuracy of optical de-coding depends on the sensitivity of fluorescence detection and spectral resolution. The sensitivity is a product of 1) excitation intensity, 2) the effective numerical aperture of the collection optics, 3) the exposure time, and 4) the spectral overlapping of the quantum dots emission. Optical decoding can be performed by fluorescence imaging or fluorescence spectroscopy. Fluorescence imaging read multiple fluorescent beads simultaneously, while fluorescence spectroscopy detect individual single bead. FIG. 4 is a perspective view of WCQB-based microspheres in the microfluidic system 56. A mixture of WCQB-based latex beads 50 are optically decoded by their fluorescent spectra 54 when excited with a light source 52 in a very small amount of sample. The flow system, in principle, is similar to the flow cytometer configuration. The microfluidic system has two advantages: (1) it makes precise centering of the particle stream possible, thus the basis for hydrodynamic focusing is established; and (2) it virtually eliminates any possibility of the channel being blocked by large microspheres in the flow stream. The optoelectronic system, for example, includes two excitation sources: a blue laser diode (410 nm) from Nichia to de-code signals and a diode. laser (638 nm, 5 mW) to excite labeled fluorophore (e.g. Cy5).

The claim of the invention is:

1. An optically-coded microsphere comprising a plurality of semiconductor-based nanometer scale crystals, said semiconductor-based nanometer scale crystals emitting various fluorescent wavelengths depending on their sizes when exposed to light, said microsphere is decoded based on the reading from said fluorescent wavelengths.

2. The optically-coded microsphere as defined in claim 1, wherein said microsphere is a polystyrene-based latex beads or magnetic beads.

3. The optically-coded microsphere as defined in claim 1 or 2, wherein said microsphere has a dimension of 0.1 μm-5 mm.

4. The optically-coded microsphere as defined in claim 1 or 2, wherein said semiconductor-based nanometer scale crystals are selected from a group consisting CdSe, InP, ZnS, CdS, CdTe, InAs, and PbS.

5. The optically-coded microsphere as defined in claim 1 or 2, wherein said semiconductor-based nanometer scale crystals have a radius of 1-10 nm.

6. The optically-coded microsphere as defined in claim 1 or 2, wherein said microsphere is immobilized with biological probes.

7. The optically-coded microsphere as defined in claim 6, wherein at least one of said biological probes is selected from a group consisting of proteins, antibodies, antigens, hormones, biological cells, and oligonucleotides.

8. An optically-coded microsphere comprising a plurality of semiconductor-based nanometer scale crystals, said semiconductor-based nanometer scale crystals emitting various fluorescent wavelengths and intensities depending on their sizes and concentration when exposed to light, said microsphere is decoded based on the reading from said fluorescent wavelengths and intensities.

9. The optically-coded microsphere as defined in claim 8, wherein said microsphere is a polystyrene-based latex beads or magnetic beads.

10. The optically-coded microsphere as defined in claim 8 or 9, wherein said microsphere has a dimension of 0.1 μm-5 mm.

11. The optically-coded microsphere as defined in claim 8 or 9, wherein said semiconductor-based nanometer scale crystals are selected from a group consisting CdSe, InP, ZnS, CdS, CdTe, InAs, and PbS.

12. The optically-coded microsphere as defined in claim 8 or 9, wherein said semiconductor-based nanometer scale crystals have a radius of 1-10 nm.

13. The optically-coded microsphere as defined in claim 8 or 9, wherein said microsphere is immobilized with biological probes.

14. The optically-coded microsphere as defined in claim 13, wherein at least one of said biological probes is selected from a group consisting of proteins, antibodies, antigens, hormones, biological cells, and oligonucleotides.
